(19) United States
(12) Patent Application Publication
(10) Pub. No.: US 2015/0318874 A1
(43) Pub. Date: Nov. 5, 2015

(54) PAIRING DEVICES USING ACOUSTIC SIGNALS

(71) Applicant: Thomas Alan Donaldson, Nailsworth (GB)

(72) Inventor: Thomas Alan Donaldson, Nailsworth (GB)

(73) Assignee: AliphCom, San Francisco, CA (US)

(21) Appl. No.: 14/266,697

(22) Filed: Apr. 30, 2014

(51) Int. Cl. H04B 1/00; H04B 11/00

(52) U.S. Cl. CPC H04B 1/00; H04B 11/00

(57) ABSTRACT

Techniques for pairing devices using acoustic signals are described. Disclosed are techniques for receiving an acoustic signal at a microphone coupled to a first device, the acoustic signal being encoded with data representing a first parameter associated with a second device, receiving an electromagnetic signal at an antenna coupled to the first device, the electromagnetic signal being encoded with data representing a second parameter associated with the second device, and determining a match between the first parameter and the second parameter. A pairing may then be generated between the first device and the second device. A pairing may include generating data representing a key, the key being configured to authenticate a pairing of the first device and the second device. A pairing may create a secure connection between the first device and the second device.

### FIELD

Various embodiments relate generally to electrical and electronic hardware, computer software, human-computing interfaces, wired and wireless network communications, telecommunications, data processing, wearable devices, and computing devices. More specifically, disclosed are techniques for pairing devices using acoustic signals, among other things.

### BACKGROUND

Personal area networks or ad hoc networks, such as Bluetooth, ZigBee, Z-Wave, and others, are becoming increasingly popular for interconnecting multiple computing devices. Conventionally, devices are generally paired or connected in an ad hoc network through the exchange of keys, addresses, or other information, using manual intervention or other mandatory processes.

Thus, what is needed is a solution for pairing devices without the limitations of conventional techniques.

### BRIEF DESCRIPTION OF THE DRAWINGS

Various embodiments or examples (“examples”) are disclosed in the following detailed description and the accompanying drawings:

FIG. 1 illustrates an example of a media device including a pairing manager, according to some examples;

FIG. 2 illustrates an example of a functional block diagram including an application architecture for a pairing manager, according to some examples;

FIGS. 3A and 3B illustrate examples of coding tables for acoustic signals, according to some examples;

FIGS. 4A and 4B illustrate data packets or portions of data packets including data representing a parameter of a device, according to some examples;

FIG. 5 illustrates an example of a sequence diagram for pairing devices, according to some examples;

FIGS. 6A, 6B, and 6C illustrate examples of identifying a device that is paired using an acoustic signal, according to some examples;

FIG. 7 illustrates an example of a process for a pairing manager, according to some examples; and

FIG. 8 illustrates a computer system suitable for use with a pairing manager, according to some examples.

### DETAILED DESCRIPTION

Various embodiments or examples may be implemented in numerous ways, including as a system, a process, an apparatus, a user interface, or a series of program instructions on a computer readable medium such as a computer readable storage medium or a computer network where the program instructions are sent over optical, electronic, or wireless communication links. In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description.

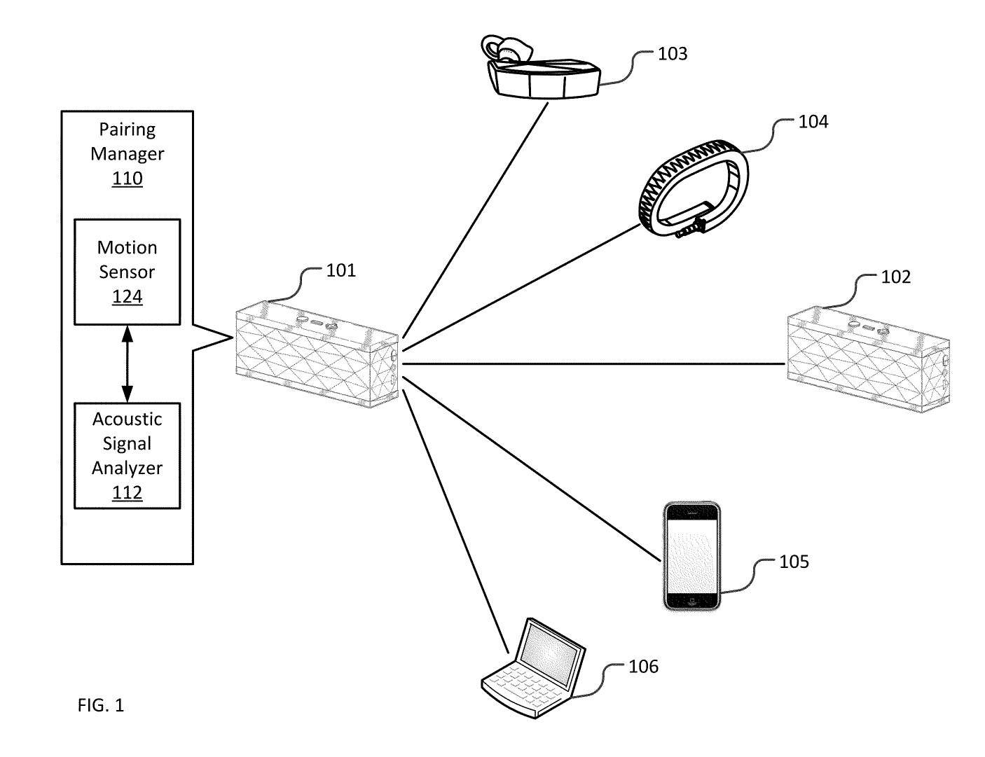

FIG. 1 illustrates an example of a media device including a pairing manager, according to some examples. As shown, FIG. 1 depicts media devices or speakers 101-102, a headset 103, a data-capable band 104, a smartphone or mobile device 105, and a laptop or computer 106. In some examples, a pairing manager 110 having an acoustic signal analyzer 112 and motion sensor 124 may be implemented in media device 101. In other examples, pairing manager 110 may be implemented on devices 102-106, or remotely (e.g., on a server). In some examples, media device 101 may be capable of being paired with devices 102-106, and other devices, over a network, such as, an ad hoc network. An ad hoc or peer-to-peer network may be created in a spontaneous manner, may require no formal infrastructure, and/or may be limited in temporal and/or spatial extent. Devices or nodes within an ad hoc network may communicate directly with each other, without the use of an access point or central server. In some examples, an ad hoc network may have a master device and one or more slave devices. A master device may provide a synchronization reference (e.g., a clock, physical channel characteristics, etc.) for a slave device. In some examples, each device in an ad hoc network may relay data for the network and cooperate in the distribution of data in the network. In some examples, an ad hoc network may include a communication link between at least two devices, including communications via acoustic signals. In some examples, the Bluetooth® data communication protocol, maintained by Bluetooth Special Interest Group (SIG) of Kirkland, Wash., may be used to establish an ad hoc network. Bluetooth Specification Version 4.0, and all versions of Bluetooth specifications, including version 4.1, 3.0+HS (High Speed), 2.1+EDR (Enhanced Data Rate), 2.0+EDR, and all addendums, maintained by Bluetooth Special Interest Group (SIG) of Kirkland, Wash., are hereby incorporated by reference for all purposes. Other examples include ZigBee, maintained by ZigBee Alliance of San Ramon, Calif., Z-Wave, maintained by Z-Wave Alliance, Wireless USB, maintained by USB Implementers Forum, Inc., and others.

The process of pairing may include creating secure communications between devices. Pairing may include creating a connection between devices, whereby the devices may transmit and receive data to and from each other. Once they are paired, devices may establish communications with each other, or if disconnected, they may reestablish communications with each other. Pairing may include generating or storing a shared key or link key, which may be used to authenticate the connection or trusted relationship between paired devices, to encrypt or decrypt communications between paired devices, to create an encryption key, and the like.

Pairing manager 110 may be configured to pair devices in an ad hoc network using acoustic signals. Pairing manager 110 may receive motion data from motion sensor 124 that prompts or triggers it to initiate a process of pairing. For example, device 101 may be bumped against another device, which may be a gesture or command signal for pairing with the other device. As another example, a user may tap or other provide a tactile or motion gesture that may initiate the pairing. Still, other command signals may be provided (e.g., a button press). Pairing manager 110 may receive an acoustic signal from media device 102 (or another device) at a microphone coupled to media device 101. An acoustic signal may be a sound wave, and may include sound, infrasound, ultrasound (e.g., ultrasonic), and the like. An acoustic signal may be composed of a compression wave that oscillates in the direction of travel through a medium (e.g., gas, air, etc.). An acoustic signal may be composed of molecules in the medium. An acoustic signal may be characterized by its frequency, amplitude, and other characteristics. An acoustic signal may be encoded to include data. For example, acoustic signals with different frequencies, amplitudes, or other characteristics may be used to transmit messages. Pairing manager 110 may use acoustic signal analyzer 112 to analyze, decode, or interpret an acoustic signal. In some examples, acoustic signal analyzer 112 may compare the acoustic signal received with one or more acoustic signal templates. An acoustic signal template may specify one or more criteria relating to a characteristic, such as a frequency range, amplitude range, feature (e.g., sudden change in frequency, etc.), duration, and the like, to, for example, identify a character, command, flag, or other meaning Acoustic signal templates may form a code, such as Morse code and the like, which may be used to communicate information. If acoustic signal analyzer 112 determines a match (e.g., a correlation) between an acoustic signal and an acoustic signal template, then acoustic signal analyzer 112 may determine the data encoded in the acoustic signal. In some examples, an acoustic signal from media device 102 may be encoded with data representing one or more parameters associated with media device 102. A parameter may include data representing a physical, functional, or other characteristic of device 102. A parameter may be an aspect that describes device 102. A parameter may or may not be unique to device 102. A parameter may be an address of device 102 (which may be unique or non-unique to device 102), a name (or other type of identifier) of device 102 (which may be unique or non-unique to device 102), one or more functionalities of device 102, and the like. A parameter may also be a number or word (or other type of identifier) that is generated by a device, such as a private key, a public key, a random number, and the like, which may be used to identify or authenticate the device. A parameter may be used to identify device 102. An acoustic signal from media device 102 may be used to identify media device 102. An acoustic signal received by media device 101 may be used by media device 101 to recognize another device that is to be paired with media device 101.

Pairing manager 101 may receive an electromagnetic or radio signal from media device 102 at an antenna coupled to media device 101. An electromagnetic signal may be a radio wave. An electromagnetic signal may be composed of translational waves that oscillate perpendicular to the direction of travel through a medium. An electromagnetic signal may be composed of photons, and may propagate in a vacuum or not in a vacuum. An electromagnetic signal may be used in data communications protocols such as Bluetooth, Wi-Fi, Near Field Communications, and the like. An electromagnetic signal may be encoded with data, using its frequency, amplitude, and other characteristics. For example, acoustic signals with different frequencies, amplitudes, or other characteristics may be used to transmit different messages, such as binary data or other data. In some examples, an electromagnetic signal from media device 102 may be encoded with data representing one or more parameters associated with media device 102. Pairing manager 101 may compare the one or more parameters encoded in the acoustic signal with the one or more parameters encoded in the electromagnetic signal to determine a match. Pairing manager 101 may then pair media device 101 and media device 102. For example, a match may be found on a parameter specifying an address of device 102. Pairing manager 101 may use the address of device 102 to pair with device 102. As another example, a match may be found on a parameter specifying a functionality of device 102. Pairing manager 101 may exchange one or more other electromagnetic signals with device 102 to pair with device 102. The one or more other electromagnetic signals may include data representing an address, key (e.g., public key, private key, etc.), or other information associated with device 102. The process of pairing may establish an ad hoc network between media device 101 and media device 102. Pairing may create a shared key or link key between media device 101 and media device 102. Pairing may create a secure connection between media device 101 and media device 102, which may be used to communicate information such as audio signals to be presented by media device 101 and media device 102, settings of media device 101 and media device 102, and the like.

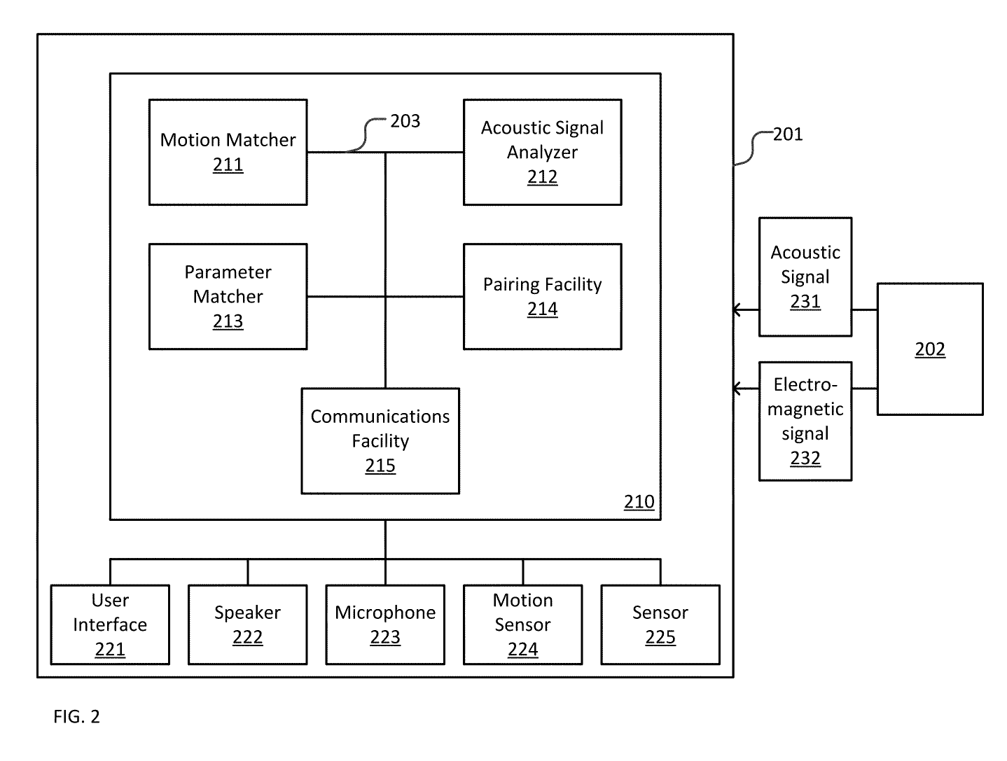

FIG. 2 illustrates an example of a functional block diagram including an application architecture for a pairing manager, according to some examples. As shown, FIG. 2 includes devices 201-202. Device 201 includes a pairing manager 210, which includes a bus 203, a motion matching facility 211, an acoustic signal analyzing facility 212, a parameter matching facility 213, a pairing facility 214, and a communications facility 215. Pairing manager 210 is further coupled to a user interface 221, a speaker 222, a microphone 223, a motion sensor 224, and a sensor 225. As used herein, “facility” refers to any, some, or all of the features and structures that may be used to implement a given set of functions, according to some embodiments. Elements 211-215 may be integrated with pairing manager 210 (as shown) or may be remote from and in data communication with pairing manager 210. Elements 221-225 may use be integrated with device 201 (as shown) or may be remote from and in data communication with device 201. Elements 221-225 may use communications facility 215 to communicate with pairing manager 210, and may use wired or wireless communications. Device 201 may receive an acoustic signal 231 and an electromagnetic signal 232 from device 202.

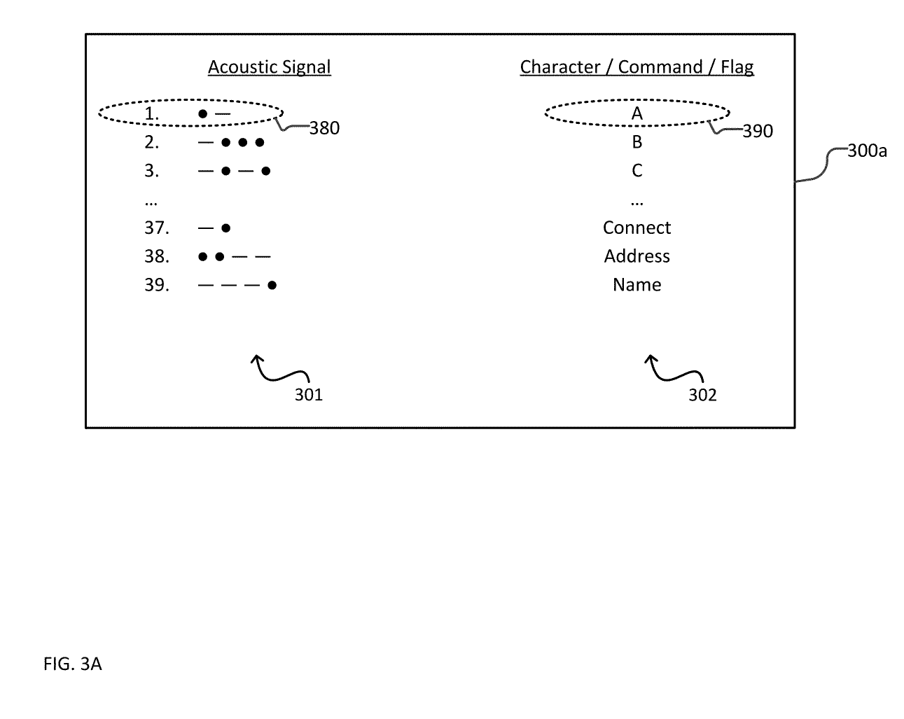

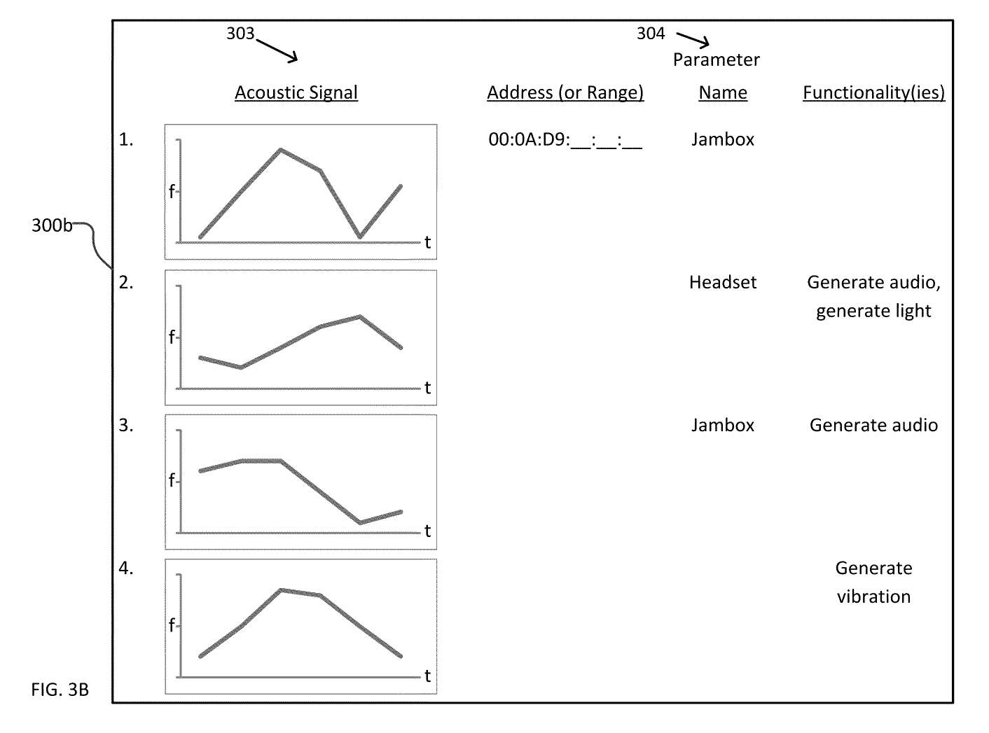

Acoustic signal analyzer 212 may be configured to analyze acoustic signal 231 received at microphone 223 to determine the data encoded in acoustic signal 231. Microphone 223 may include one or more transducers or microphones. Microphone 223 may be activated to receive acoustic signal 231 based on a control signal from motion matcher 211 (described below) or another facility. Acoustic signal 231 may be received from device 202, which may be prompted to initiate a pairing with device 201. Acoustic signal 231 may be encoded with data representing a parameter associated with device 202, such as an address, name, functionality, feature, or the like of device 202. Acoustic signal 231 may be encoded using the characteristics of acoustic signal 231, such as its frequency, amplitude, duration, and the like. Acoustic signal analyzer 212 may analyze acoustic signal 231 to determine one or more of its characteristics. Acoustic signal analyzer 212 may compare acoustic signal 231 to one or more acoustic signal templates to determine a match. An acoustic signal template may include one or more conditions or criteria associated with an acoustic signal, and may specify one or more characteristics of an acoustic signal. An acoustic signal template may be associated with a character, code, command, flag, or other meaning. Acoustic signal analyzer 212 may compare acoustic signal 231 with the acoustic signal template and determine a match using pattern matching. Acoustic signal analyzer 212 may compare a characteristic of acoustic signal 231 with a condition and determine if acoustic signal 231 satisfies the condition. A match may be found within a certain tolerance or range. When a match with an acoustic signal template is found, acoustic signal analyzer 212 may determine the data encoded in acoustic signal 231 using the meaning or code associated with the acoustic signal template. Acoustic signal analyzer 212 may decode, interpret, or convert acoustic signal 231 into data, which may include data representing a parameter associated with device 202. Acoustic signal analyzer 212 may look up the code of an acoustic signal using a coding table (see, e.g., FIGS. 3A and 3B). As described above, a parameter may be a physical, functional, or other characteristic of device 202, including its address, name, functionality, and the like.

Communications facility 215 may include a wireless radio, control circuit or logic, antenna, transceiver, receiver, transmitter, resistors, diodes, transistors, or other elements that are used to transmit and receive data from other devices. In some examples, communications facility 215 may be implemented to provide a “wired” data communication capability such as an analog or digital attachment, plug, jack, or the like to allow for data to be transferred. In other examples, communications facility 215 may be implemented to provide a wireless data communication capability to transmit digitally-encoded data across one or more frequencies using various types of data communication protocols, such as Bluetooth, ZigBee, Wi-Fi, 3G, 4G, without limitation. An antenna may be any electrical device that may be used to convert electric power into electromagnetic or radio waves, and vice versa. An antenna may be omnidirectional, directional, vertical, dipole, or other types. An antenna coupled to communications facility 215 may be configured to receive electromagnetic signal 232, which may be encoded with data representing a parameter associated with device 202. Communications facility 215 may convert or decode electromagnetic signal 232 into data, including data representing a parameter associated with device 202. Communications facility 215 may also be used to receive other data from device 202, including additional parameters associated with device or other information that may be used to pair device 201 and device 202.

Parameter matcher 213 may be configured to compare the data representing a parameter associated with device 202 decoded from acoustic signal 231 and the data representing a parameter associated with device 202 decoded from electromagnetic signal 232, and to determine a match between the two parameters. For example, acoustic signal 231 may be encoded with an address of device 202. An address may be a substantially unique identifier of device 202. A Bluetooth address, for example, may be a 48-bit address, which may be presented as a 12-digit hexadecimal number. As another example, an address may be a non-unique identifier of an address. For example, a master device (or a device initiating a pairing) may assign an address to a slave device (or a device responding to a pairing request). Electromagnetic signal 232 may also be encoded with an address of device 202. Parameter matcher 213 may compare the address from acoustic signal 231 and the address from electromagnetic signal 232 and determine a match. Based on the match, pairing manager 210 may use the address of device 202 to identify device 202 as a device that has been prompted to pair with device 201. As another example, acoustic signal 231 may be encoded with a name of device 202. A name of device 202 may be a non-unique, user-friendly name that may be used to identify device 202. A name may include a brand name, a model name, a trademark, a manufacturer, a type of the device, and the like. For example, device 202 may be a Jambox® media device, produced by AliphCom of San Francisco, Calif. A name of device 202 may be “Jambox,” “media device,” “Jambox media device,” and the like. Electromagnetic signal 232 may also be encoded with a name of device 202. Parameter matcher 213 may compare the name from acoustic signal 231 and the name from electromagnetic signal 232 and determine a match. Based on the match, pairing manager 210 may use the name of device 202 to identify device 202 as a device that has been prompted to pair with device 201. In some examples, electromagnetic signal 232 may include the address of device 202 and another parameter associated with device 202 that is not the address of device 202 (e.g., a name of device 202). Pairing manager 210 may determine a match between the parameter from acoustic signal 231 and the parameter from electromagnetic signal 232, and then use the address of device 202 included in electromagnetic signal 232 to identify device 202 as a device that has been prompted to pair with device 201.

Pairing facility 214 may be configured to pair device 201 and device 202 based on the match determined by parameter matcher 213. For example, pairing facility 214 may create an ad hoc network between device 201 and device 202. Pairing facility 214 may enable secure communications between device 201 and device 202. Pairing facility 214 may create a shared key or link key between device 201 and device 202, which may be used to authenticate a connection or trusted relationship between device 201 and device 202, to exchange encrypted data between device 201 and device 202, and the like. A key may be a password or piece of information that may be used to authenticate, encrypt, or decrypt data. A shared key among multiple devices may be a key that is known to the multiple devices. For example, after devices 201-202 have been paired, and each has stored a link key, device 201 may transmit a random number to device 202, and device 201 and device 202 may each perform an operation as a function of the link key and the random number, resulting in a first output and a second output, respectively. Device 201 may receive the second output (which was computed by device 202) from device 202, and compare it with the first output (which was computed by device 201). If the two outputs are the same, then device 202 may be authenticated as a trusted device that shares a link key with device 201. In another example, devices 201-202 may use the link key to encrypt data or create encryption keys, and exchange the encrypted data with each other. Devices 201-202 may decrypt the data based on the like key. Then devices 201-202 may authenticate each other. Other methods of authentication and encryption may also be used. Pairing facility 214 may create a shared key between device 201 and device 202 based on parameters or other information associated with device 201 and device 202, which may include a key of device 201, a key of device 202, an address of device 201, an address of device 202, a random or pseudo-random number or nonce of device 201, a random or pseudo-random number or nonce of device 202, and the like.

Once the devices 201-202 are paired, devices 201-202 may further exchange data that may be used to interact with each other, to perform joint operations, and the like. For example, after being paired, devices 201-202 may be used to provide special sound effects, such as surround sound, two-dimensional (2D), or three-dimensional (3D) audio, and the like. Surround sound is a technique that may be used to enrich the sound experience of a user by presenting multiple audio channels from multiple speakers. 2D or 3D audio may be a sound effect produced by the use multiple speakers to virtually place sound sources in 2D or 3D space, including behind, above, or below the user, independent of the real placement of the multiple speakers. In some examples, at least two transducers operating as loudspeakers can generate acoustic signals that can form an impression or a perception at a listener's ears that sounds are coming from audio sources disposed anywhere in a space (e.g., 2D or 3D space) rather than just from the positions of the loudspeakers. In presenting special sound effects, different audio channels may be mapped to different speakers. For example, pairing manager 210 may prompt speaker 222 coupled to device 201 to generate an audio signal comprising a first audio channel. Pairing manager 210 may transmit a control signal to generate a second audio channel at device 202, and may transmit data representing the second audio channel to device 202. The control signal, or other data, may be transmitted to device 202 over the ad hoc network created by pairing facility 214. The control signal or other data transmitted to device 202 may be authenticated or encrypted based on a shared key or link key. As another example, after being paired, devices 201-202 may share settings with each other. A setting may be information used to adjust an operation of a device, and may include personalization or customization of the operation of a device. A setting may include, for example, sound settings (e.g., adjustment of bass, treble, etc.), alarm settings (e.g., a time at which an audio signal is presented), a playlist (e.g., a list of favorite songs), information about a user (e.g., demographic information, sex, age, etc.), and the like. Settings data may be communicated between devices 201-202 using an ad hoc network or secure connection. Still, pairing manager 210 may initiate or cause other operations to be performed by devices 201-202.

Motion matcher 211 may be configured to analyze motion data received from motion sensor 224 to determine whether a motion or gesture has been received to prompt or initiate the process of pairing devices using acoustic signals. Motion sensor 224 may be one or more sensors, and may include an accelerometer, gyroscope, inertial sensor, or other sensor that may be used to detect a motion or motion vector. A motion sensor may detect a motion vector with more than one component or axis, such as a 2- or 3-axis accelerometer. For example, device 201 may be configured to pair with another device using acoustic signals after device 201 has been “bumped” by a user. A bump may be associated with a change in acceleration of a device, such as when the device contacts, taps, knocks, hits, or collides with another object, such as another device. A user may bump device 201 against device 202, or another object. The bump may constitute a gesture or signal to device 201 to pair with another device using acoustic signals. Motion matcher 211 may store one or more templates or conditions associated with a “bump” or another motion used to prompt a pairing using acoustic signals. For example, a condition associated with a bump may include a sudden change in acceleration, in terms of magnitude, direction, and/or another parameter. A condition associated with a bump may include a threshold, and the change in motion data must be greater than the threshold in order for the condition to be met. Motion matcher 211 may compare motion data from motion sensor 224 to one or more templates or conditions to determine a match. If a match is found, then motion matcher 211 may prompt or enable pairing manager 210 to pair with another device using acoustic signals. Once a match is found, pairing manager 210 may attempt to pair with another device using acoustic signals for a certain time period. For example, pairing manager 210 may listen for an acoustic signal for a certain time period, e.g., 30 seconds, after a bump. After the time period, pairing manager 210 may deactivate microphone 223, or may stop analyzing acoustic signals received at microphone 223 using acoustic signal analyzer 212. Similarly, there may be a time period in which electromagnetic signal 232 should be received by device 201. Thus, in some examples, for pairing to successfully occur, device 202 may need to provide acoustic signal 231 and electromagnetic signal 232 within certain time periods after a bump or other gesture is received by device 201. Still, other command signals may be used to prompt pairing with another device using acoustic signals, such as a pressing of a button coupled to device 201, an entry of a command via user interface 221 of device 201, a detection of a proximity between device 201 and a user or a wearable device of a user, and the like. Sensor 225 may be used in lieu of or in addition to motion sensor 224 to detect a command signal to pair with another device using acoustic signals. Sensor 225 may include a location sensor (e.g., Global Positioning Service (GPS) receiver or other location sensor), a thermometer, an altimeter, a light sensor, a proximity sensor, and the like. A proximity sensor may, for example, determine the proximity of a device using the power or strength of a signal emitted from the device. A proximity sensor may, for example, determine the proximity of a device, person, or object using ultrasonic signals and the like. Sensor 225 may also be used for other purposes.

In some examples, after pairing manager 210 is prompted to pair with another device using acoustic signals, microphone 223 may be turned on to receive acoustic signals, and the acoustic signals may be processed by acoustic signal analyzer 212. In some examples, speaker 222 may also be turned on to generate an acoustic signal. Speaker 222 may include one or more transducers or loudspeakers. In some examples, device 201 may receive acoustic signal 231 at microphone 223 at substantially the same time as when device 201 transmits another acoustic signal at speaker 222. In some examples, device 201 may receive acoustic signal 231 within a certain time period before or after device 201 transmits another acoustic signal. The acoustic signal transmitted by device 201 may be encoded with data representing a parameter associated with device 201. Device 201 may also transmit an electromagnetic signal encoded with data representing a parameter associated with device 201. Device 202 may receive the acoustic signal and electromagnetic signal from device 201. Device 202 may have a pairing manager similar to pairing manager 210, which may compare the parameter from the acoustic signal from device 201 and the parameter from the electromagnetic signal from device 201. Thus, device 201 and device 202 may each perform a matching of data of an acoustic signal and data of an electromagnetic signal, and may each confirm or acknowledge a pairing with each other. For example, device 201 may determine a match between a parameter encoded in acoustic signal 231 and a parameter encoded in electromagnetic signal 232, and may transmit a request to device 202 to pair with device 202. Device 202 may also determine a match between a parameter encoded in an acoustic signal received by device 202 and a parameter encoded in an electromagnetic signal received by device 202. Device 202 may receive the request to pair from device 201. Device 202 may transmit a response to device 201 confirming or agreeing to pair with device 201. Devices 201 and 202 may exchange further information and be paired with each other.

User interface 221 may be configured to exchange data between device 201 and a user. User interface 221 may include one or more input-and-output devices, such as a keyboard, mouse, audio input (e.g., speech-to-text device), display (e.g., LED, LCD, or other), monitor, cursor, touch-sensitive display or screen, and the like. User interface 221 may be used to enter a user command to initiate a process of pairing using acoustic signals. User interface 221 may be used to create or modify an acoustic signal template, a coding table used for decoding an acoustic signal, or other information used for analyzing an acoustic signal. For example, a user may use a user interface to select an acoustic signal template that is stored in memory. A user may enter through the user interface a parameter associated with a device. A user may associate the selected acoustic signal template and the parameter, which may be a new or modified entry in a coding table. When a match is determined between this acoustic signal template and an acoustic signal that is received at the device, the acoustic signal may be decoded or interpreted as having data representing the parameter entered by the user. User interface 221 may be used to create or modify a parameter associated with device 201, such as its name, address, functionality, and the like. Still, user interface 221 may be used for other purposes.

FIGS. 3A and 3B illustrate examples of coding tables for acoustic signals, according to some examples. As shown, FIG. 3A includes a table 300a, having a list or group of acoustic signal templates 301, mapped to a list or group of meanings or codes (e.g., a character, command, flag, etc.) 302. List 301 includes a first entry 380, and list 302 includes a first entry 390. Entry 380 may be mapped to or associated with entry 390. FIG. 3B includes a table 300b, having a list or group of acoustic signal templates 303, mapped to a list or group of meanings or codes 304 (e.g., a parameter, a name, an address (or address range), a functionality, etc.). An acoustic signal template may include one or more conditions or criteria related to an acoustic signal, such as an acoustic signal's frequency, amplitude, duration, or other characteristic. In some examples, a coding table may be similar to or be modified based on a Morse code table. In Morse code, for example, each character (e.g., letter, numeral, etc.) may be represented by a unique sequence of dots and dashes. A dot represents a signal of a short duration, and a dash represents a signal of a long duration (e.g., a dash's duration may be three times longer than a dot's duration). Each dot or dash is followed by a short silence (e.g., equal to a duration of a dot). Each character may be separated by a long silence (e.g., equal to three times the duration of a dot). Each word made up of the characters may be separated by a longer silence (e.g., equal to seven times the duration of a dot). Similarly, acoustic signal templates may be represented by sequences of dots and dashes, wherein the dots and dashes represent a certain duration of an acoustic signal. The acoustic signal may be required to have a frequency and amplitude within certain ranges. For example, as shown, the first acoustic signal template 380 in list 301 is a dot and a dash. Thus, an acoustic signal would match the first acoustic signal template 380 if it generates a frequency and amplitude within the required ranges for a short duration (e.g., a duration of a dot), followed by silence (or a frequency or amplitude that is outside a required range) for a short duration (e.g., a duration of a dot), followed by a frequency and amplitude within the required ranges for a long duration (e.g., the duration of three dots). A match may be found between an acoustic signal and an acoustic signal template if there was a substantial similarity or a match within a tolerance. A tolerance may be defined by a length of time (e.g., 0.1 seconds), a percentage (e.g., 5% of the expected value), and the like. For example, a tolerance level may be 5%, and an acoustic signal may have a period of silence between a dot and a dash that is 95% of the duration of a dot. The acoustic signal may be found to match the first acoustic signal 380 of list 301. In some examples, a match may be found when there is a best match between the acoustic signal and the acoustic signal templates listed in list 301. The best match may be the acoustic signal template having the least difference with the acoustic signal. Each acoustic signal template in list 301 may be mapped to a meaning in list 302. List 302 may include characters, commands, flags, or other meanings. A coding table may map an acoustic signal template to a character, command, flag, or other meaning. Thus a sequence of acoustic signals may be decoded into a sequence of characters, which may together form a meaning or message, such as an address of a device. As shown, the character “A” 390 maps to the first acoustic signal 380. Thus, an acoustic signal matching the first acoustic signal template 380 may be decoded or converted to data representing an “A.” A sequence of acoustic signals may be received, which may be mapped to a sequence of characters, which may together form or spell out a meaning or message. The sequence of acoustic signals may be separated by periods of silence, and, for example, a long period of silence (e.g., three times the duration of a dot) may be used to separate characters, and a longer period of silence (e.g., seven times the duration of a dot) may be used to separate words that are formed by the characters. For example, an acoustic signal may spell out an address of a device, a name of a device, a functionality of a device, or another parameter of a device. In some examples, an acoustic signal template may be mapped to a command or flag. For example, as shown, the 37th acoustic signal template of list 301 is mapped to the command “Connect” of list 302. This command may be used at the beginning of an acoustic signal to indicate that subsequent data encoded in the acoustic signal may be used for connecting or pairing with another device. As shown, the 38th and 39th acoustic signal templates of list 301 are mapped to the flags “Address” and “Name,” respectively, of list 302. This flag may be used to indicate that subsequent data encoded in the acoustic signal may be related to the flag. In one example, a device may receive an acoustic signal, which maps to the following data: “Connect,” “Name,” “M,” “E,” “D,” “I,” “A,” “space,” “D,” “E,” “V,” “I,” “C,” “E.” This acoustic signal may indicate to the receiving device that the transmitting device would like to connect, and the name of the transmitting device is “media device.” The receiving device may use this data to pair with the transmitting device. Other characters or meanings may be included in list 302, including special characters such as “!”, “_,” and the like, and other commands, flags, or meanings.

In some examples, an acoustic signal template may be a pattern composed of characteristics or a range of characteristics of an acoustic signal, such as its frequency, amplitude, duration, and the like. As shown in FIG. 3B, list 303 includes acoustic signal templates. As shown, the acoustic signal templates are based on the frequency of an acoustic signal as a function of time. For example, the first acoustic signal template of list 303 shows an acoustic signal beginning with a low frequency, which increases, drops, and then ends at an intermediate frequency. The second acoustic signal template of list 303 shows a frequency of an acoustic signal which begins at an intermediate level, slightly drops, gradually increases, and gradually drops. In some examples, an acoustic signal template may be based on alternative or additional characteristics. For example, an acoustic signal template may include a pattern or condition for an amplitude of an acoustic signal. In one example, a device may receive an acoustic signal, and an acoustic signal analyzer of the device may analyze the acoustic signal to determine its characteristics. The acoustic signal analyzer may then compare the characteristics of the acoustic signal to one or more acoustic signal templates to determine a match. A match may be determined based on a substantial similarity, a match within a tolerance, pattern matching, and the like. For example, a tolerance level may be set at 5%, and a frequency of an acoustic signal may be within 5% of the frequency specified in an acoustic signal template over a time period. Then a match may be found. For example, a frequency of an acoustic signal may be within a certain range of the frequency specified in an acoustic signal template over 95% of the time period specified in the acoustic signal template. A match may also be found. Still, other implementations of finding a match may be used. A coding table may map an acoustic signal template to a complete or partial meaning, such as an address, address range, name, and one or more functionalities. As shown, for example, list 304 includes parameters of a device, including an address (or address range), a name, and functionalities. For example, as shown, the first acoustic signal template of list 303 maps to the following parameters of list 304: an address range, “00:0A:D9:_:_:_”, and a name, “Jambox.” A Bluetooth address may be composed of 12 hexadecimal digits. A Bluetooth address may use the first 6 digits to indicate a manufacturer or supplier of the Bluetooth-enabled device, and the last 6 digits may be assigned by the manufacturer or supplier. An address range “00.0A:D9:_:_:_” may indicate that the first 6 digits need to match “00:0A:D9” but the last 6 digits may be any number. This address range may be used to specify a manufacturer or supplier of a Bluetooth-enabled device. Still, other addresses, address ranges, address types and formats, and the like may be included in list 304. An acoustic signal from a transmitting device that matches the first acoustic signal template of list 303 may indicate one or more parameters of the transmitting device, for example, that an address of the transmitting device is within the range “00:0A:D9:_:_:_” and the name of the transmitting device is “Jambox,” as shown in list 304. The parameters listed within list 304 may be a subset or comprehensive list of parameters associated with a device. For example, an acoustic signal that matches the second acoustic signal template of list 303 may indicate that the name of the transmitting device is “headset” and one or more functionalities of the transmitting device includes “generating audio” and “generating light,” as shown in list 304. However, the functionalities listed in list 304 may be a subset of the functionalities of the transmitting device, and other functionalities may be performed by the transmitting device. A coding table may include a list of parameters 304 with a plurality of parameter types, and the parameters mapping to each acoustic signal template may include all or some of the parameter types. For example, as shown, the first acoustic signal template of list 303 may be mapped to an address range and a name, but the “functionality” parameter type may be left blank. A blank under a parameter type may indicate that the data for this parameter type is unknown or irrelevant to the process of pairing devices using acoustic signals. Thus, an acoustic signal matching the first acoustic signal template may indicate that the transmitting device has an address within the address range “00:0A:D9:_:_:_”, has a name “Jambox,” and has any number or types of functionalities. Still, other implementations of a coding table may be used. Data included in an acoustic signal that is decoded or interpreted using a coding table may be used by a pairing manager. For example, such data may be compared with data encoded in an electromagnetic signal, the result of which may be used to identify a device for pairing.

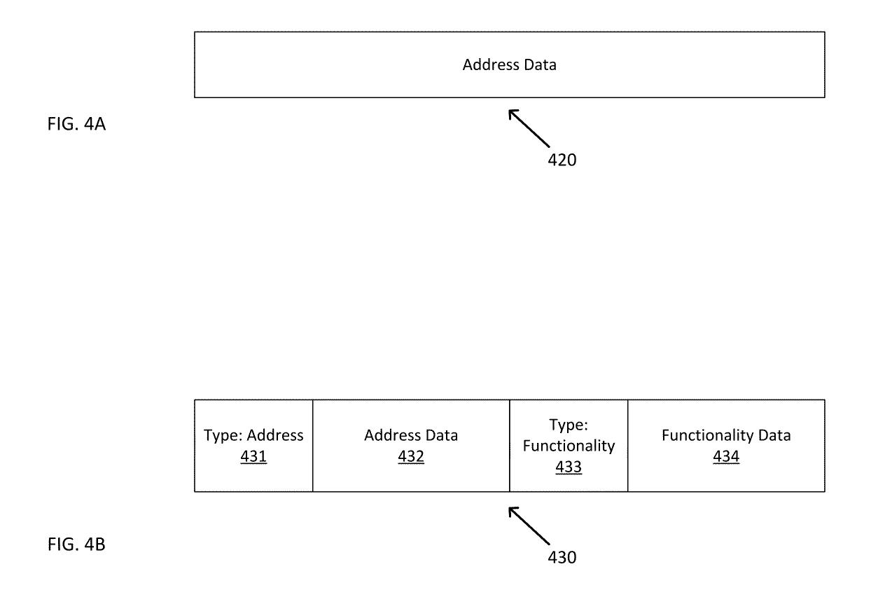

FIGS. 4A and 4B illustrate data packets or portions of data packets including data representing a parameter of a device, according to some examples. A data packet may include a variety of types of information. As shown in FIG. 4A, for example, a data packet or portion of a data packet 420 may include data representing an address of a transmitting device. As shown in FIG. 4B, for example, a data packet or portion of a data packet 430 may include flags followed by data content. For example, a flag may indicate a type of data content that follows the flag. For example, a flag 431 may indicate that the following data content represents an address of the transmitting device, and data content 432 may indicate the address of the transmitting device (e.g., a 48-bit identifier of the transmitting device, and the like). A flag 433 may indicate that the following data content represents a functionality of the transmitting device, and data content 434 may indicate one or more functionalities. Other parameters of a device, and other information, may also be included in data packet 430. In some examples, a portion of a data packet may be considered a header, and another portion of a data packet may be considered a payload. For example, flag 431 and data content 432 may be considered a part of a header, while flag 433 and data content 434 may be considered a part of a payload. Data packets 420 and 430 may be transmitted using electromagnetic waves. Data packets 420 and 430 may be transmitted using a variety of wireless communications protocols, including Bluetooth, ZigBee, Wi-Fi, and the like. Data packets 420 and 430 may be portions of an advertising packet or broadcast data packet, such as an advertising data packet specified under the Bluetooth specifications, or a data packet under another communications protocol. An advertising packet or broadcast data packet may be transmitted between devices without an established or secured communication link between the devices. An advertising packet may be transmitted without authenticating or encrypting the data using a key. An advertising packet may be transmitted to a recipient device without the transmitting device being aware of the identity of the recipient device. Data encoded in data packets 420 and 430 may be received by a device having a pairing manager, and the pairing manager may compare the data with data included in an acoustic signal. The pairing manager may pair the transmitting device and the receiving device based on the comparison.

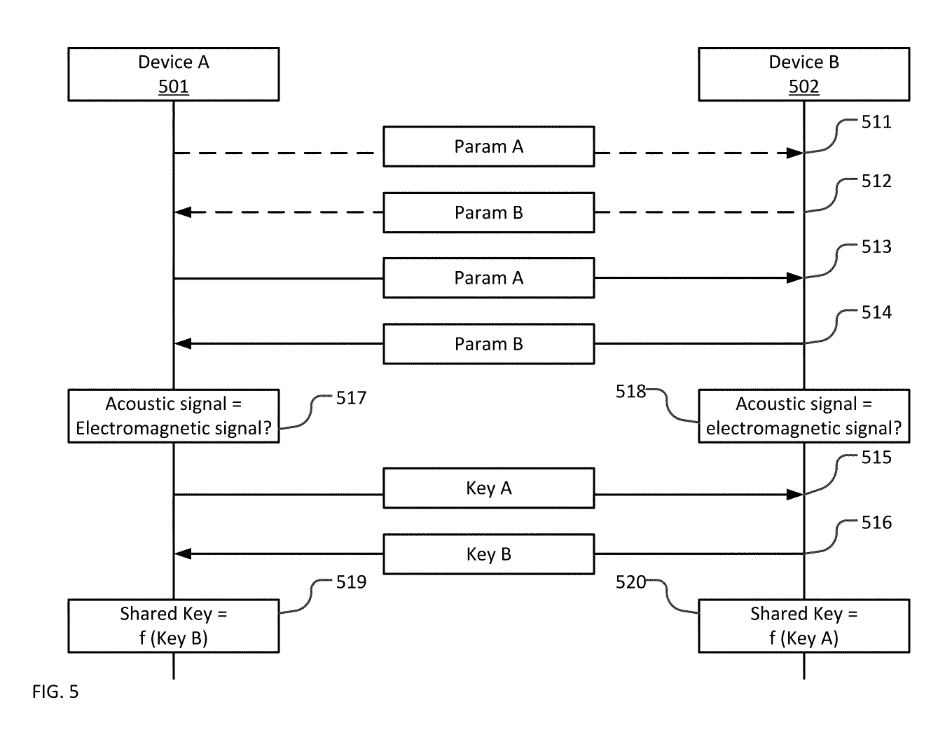

FIG. 5 illustrates an example of a sequence diagram for pairing devices, according to some examples. As shown, FIG. 5 includes device “A” 501, device “B” 502, an acoustic signal 511 encoded with data representing “Parameter A,” an acoustic signal 512 encoded with data representing “Parameter B,” an electromagnetic signal 513 encoded with data representing “Parameter A,” an electromagnetic signal 514 encoded with data representing “Parameter B,” an electromagnetic signal 515 encoded with data representing “Key A,” and an electromagnetic signal 516 encoded with data representing “Key B,” a comparison 517 of an acoustic signal and an electromagnetic signal received by device A, a comparison 518 of an acoustic signal and an electromagnetic signal received by device B, a computation or determination 519 of a shared key or link key by device A, and a computation or determination 520 of a shared key or link key by device B. As shown, acoustic signals are indicated by the dotted lines, and electromagnetic signals are indicated by the solid lines. Initially, device A 501 and device B 502 may each receive a prompt to begin the process of pairing using acoustic signals. In one example, device A 501 and device B 502 may each have a motion matcher to determine whether device A 501 and device B 502 have received a bump, which may trigger device A 501 and device B 502 to begin the process of pairing using acoustic signals. In some examples, the motion matcher may further determine whether device A 501 and device B 502 have been bumped against each other. The motion matcher of device A 501 may use, for example, a proximity sensor, to detect whether device B 502 is within a proximity. If so, and a motion sensor of device A 501 senses a bump, then the motion matcher of device A 501 may determine that device A 501 has been bumped against device B 502. Other methods of determining whether device A 501 and device B 502 have been bumped against each other may also be used.

After device A 501 is prompted to pair using acoustic signals, device A 501 may transmit an acoustic signal encoded with data representing a parameter of device A 501, “Parameter A” 511. After device B 502 is prompted to pair using acoustic signals, device B 502 may transmit an acoustic signal encoded with data representing a parameter of device B 502, “Parameter B” 512. Substantially at the same time, or within a time period before or after the transmission of “Parameter A” 511, device A 501 may turn on its microphone to listen for acoustic signals, and may analyze the acoustic signals received. Device A 501 may receive the acoustic signal 512. Device B 502 may also turn on its microphone to listen for acoustic signals, and may analyze the acoustic signals received. Device B 502 may receive the acoustic signal 511. Device A 501 and device B 502 may analyze acoustic signals 512 and 511 to decode or interpret the data included in acoustic signals 512 and 511, respectively. The decoding may be done with a coding table. For example, an acoustic signal analyzer of device A 501 may compare acoustic signal 512 with one or more acoustic signal templates included in a coding table. After finding a match with an acoustic signal template, the acoustic signal analyzer of device A 501 may determine a meaning of acoustic signal 512. Similarly, device B 502 may determine a meaning of acoustic signal 511. Thus, device A 501 may determine that acoustic signal 512 is encoded with data representing “Parameter B” and device B 502 may determine that acoustic signal 511 is encoded with data representing “Parameter A.” Acoustic signals 511 and 512 may also be encoded with other data.

Device A 501 may also transmit an electromagnetic signal encoded with data representing “Parameter A” 513, and device B 502 may also transmit an electromagnetic signal encoded with data representing “Parameter B” 514. The electromagnetic signals 513 and 514 may be transmitted using a wireless communications protocol such as Bluetooth. The electromagnetic signals 513 and 514 may include data packets for transmitting the data representing “Parameter A” and “Parameter B,” respectively. In some examples, such data packets may be advertising packets or broadcast data packets. In some examples, such data packets may be transmitted as part of a connection request, a response to a connection request, a handshake process for pairing devices, and the like. A communications facility having an antenna coupled to device A 501 may receive electromagnetic signal 514 and a communications facility having an antenna coupled to device B 502 may receive electromagnetic signal 513. Device A 501 and device B 502 may decode or convert electromagnetic signals 514 and 513, respectively, into data. Thus, device A 501 may determine that electromagnetic signal 514 is encoded with data representing “Parameter A” and device B 502 may determine that electromagnetic signal 513 is encoded with data representing “Parameter B.” Electromagnetic signals 513 and 514 may also be encoded with other data.

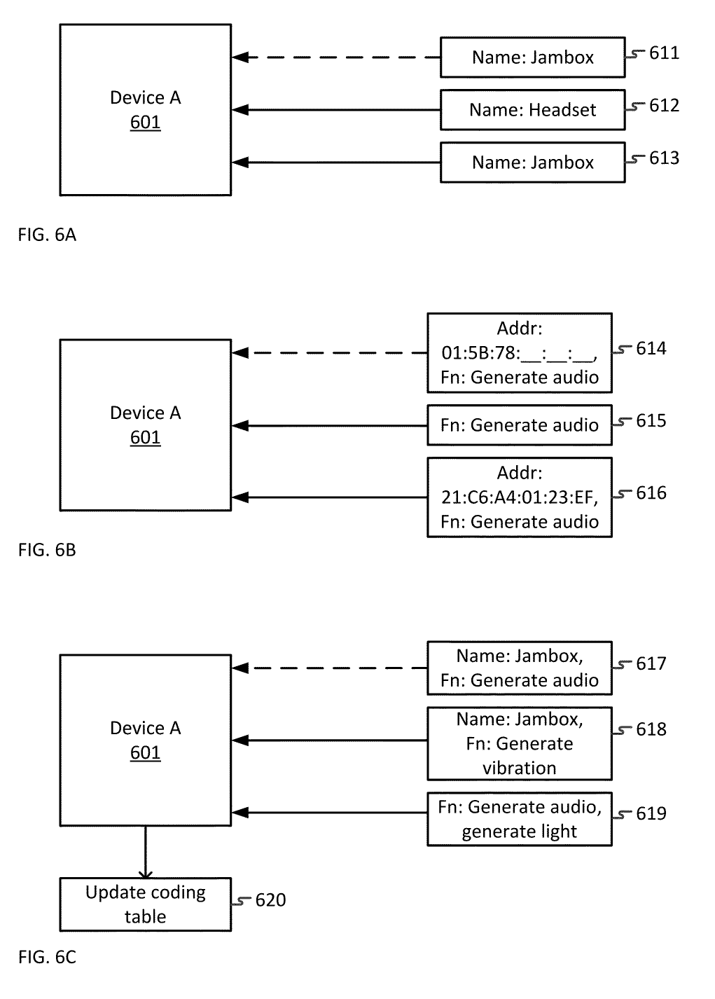

Device A 501 may compute or perform a comparison 517 to compare the parameter received from acoustic signal 512 to the parameter received from acoustic signal 514, and device B 502 may perform a comparison 518 to compare the parameter received from acoustic signal 511 to the parameter received from acoustic signal 513. In some examples, comparisons 517 and 518 may determine a match. For example, if the parameter received from acoustic signal 512 and the parameter received from acoustic signal 514 are the same or substantially the same, or include a piece of information that is the same or substantially the same, then comparison 517 may determine a match. In some examples, comparisons 517 and 518 may determine a match based on a best match. For example, comparison 517 may determine that out of a plurality of acoustic signals received by device A 501 (not shown), acoustic signal 512 is encoded with a parameter or data that is a best match for the parameter or data of electromagnetic signal 514. A best match may be determined based on a level of similarity amongst one or more parameters, the weight or significance of one or more parameter types, and the like (see, e.g., FIGS. 6A, 6B, and 6C). After comparison 517 determines a match, device A 501 may initiate or continue the process of pairing with device B 502. After comparison 518 determines a match, device B 502 may initiate or continue the process of pairing, or respond to device A 501's pairing request, to pair with device A 501.

In some examples, pairing may involve generating a shared key or link key between device A 501 and device B 502. The generation of a link key may involve a number of steps, including generation and exchange of nonces, generation and exchange of keys (e.g., private keys, public keys, etc.), and the like. In some examples, device A 501 may transmit an electromagnetic signal 515 to device B 502 including data representing “Key A,” and device B 502 may transmit an electromagnetic signal 516 to device A 501 including data representing “Key B.” In some examples, data representing “Key A” and “Key B” may be transmitted via other channels, such as an acoustic wave, or other. In some examples, “Key A” may be a public key of device A 501 and “Key B” may be a public key of device B 502. In some examples, device A 501 may perform a computation or determination 519 of a shared key as a function of “Key B,” and device B 502 may perform a computation 520 of a shared key as a function of “Key A.” Other input may also be used in computations 519 and 520. Based on determinations 519 and 520, a shared key may be derived by device A 501 and device B 502 and may be used by device A 501 and device B 502 to authenticate a pairing or trusted relationship between them. Under the Bluetooth specifications, for example, device A 501 and device B 502 each has a public-private key pair, which may be generated using an Elliptic Curve Diffie-Hellman (ECDH). Device A 501 may transmit “Key A” to device B 502, which may be the public key of device A 501. Device B 502 may transmit “Key B” to device A 501, which may be the public key of device B 502. Device A 501 may then compute a third key as a function of the public key of device B 502 and the private key of device A 501. Device B 502 may compute a fourth key as a function of the public key of device A 501 and the private key of device B 502. Using Diffie-Hellman encryption, or another methodology, the third key computed by device A 501 and the fourth key computed by device B 502 may be the same and may be used as a common key between device A 501 and device B 502. Further, in some examples, device A 501 may transmit a nonce or random number to device B 502, and device B 502 may transmit a nonce or random number to device A 501 (not shown). These nonces may be used to authenticate device A 501 and device B 502. In some examples, a link key created in the pairing of device A 501 and device B 502 may be generated as a function of the common key between device A 501 and device B, the nonces generated by device A 501 and device B, and/or other information. In some examples, the order of the transmission of signals and data may be different. For example, data representing “Key A” and “Key B” 515 and 516 may be transmitted before data representing “Parameter A” and “Parameter B” 513 and 514.

In some examples, “Parameter A” and “Parameter B” may be addresses of device A 501 and device B 502, respectively. The addresses may be any type of address or identifier of device A 501 and device B 502. The addresses may be used in a pairing process to identify the devices to be paired. For example, device A 501 may transmit its address using acoustic signal 511, and device B 502 may transmit its address using acoustic signal 512. Device A 501 may then transmit electromagnetic signal 513 encoded with an address of device A 501, and device B may transmit electromagnetic signal 514 encoded with an address of device B 502. The address data may be included in a header of a data packet transmitted using electromagnetic signals 513-514. Electromagnetic signals 513 and 514 may further be encoded with other information, including “Key A,” “Key B,” nonces, and others. Comparison 517 may determine a match between the addresses in acoustic signal 512 and electromagnetic signal 514, which may indicate that electromagnetic signal 513 originates from a device that is undergoing a process to pair using acoustic signals or has been prompted to pair with device A 501. Comparison 518 may determine a match between the addresses in acoustic signal 511 and electromagnetic signal 513. Device A 501 and device B 502 may exchange further data or data packets, such as electromagnetic signals 515 and 516, acoustic signals, or others. Each data packet may also include the address of the transmitting device, which may be used to determine that the data packet originates from a device that is undergoing a pairing process using acoustic signals. The information in the data packets exchanged, such as signals 513-516, may include “Key A,” “Key B,” other keys, nonces, and other information, which may be used to pair device A 501 and device B 502. A link key may be generated as a function of this information. The link key may be stored by device A 501 and device B 502. The link key may be used in subsequent communications between device A 501 and device B 502 to authenticate a trusted relationship. The link key may be used to encrypt communications between device A 501 and device B 502, or to create encryption keys to be used by device A 501 and device B 502.

In some examples, “Parameter A” and “Parameter B” may be a functionality of device A 501 and device B 502, respectively. For example, “Parameter A” may be “generating audio,” and “Parameter B” may be “generating audio.” The electromagnetic signal 513 generated by device A 501 may include “generating audio” as well as an address or identifier of device A 501 and other information (e.g., a connectable advertising packet, a connection request, etc.). The electromagnetic signal 514 generated by device B 502 may include “generating audio” as well as an address or identifier of device B 502 and other information (e.g., a connection request, a response to a connection request, etc.). Comparisons 517 and 518 may determine matches between signals 512 and 514 and between signals 511 and 513, respectively. Then the addresses included in electromagnetic signals 513-514 may be used to identify the devices that have been prompted to pair with each other. Device A 501 and device B 502 may exchange further data packets, including signals 515-516. An address of device A 501 and/or an address of device B 502 may be included in each data packet, or a header of each data packet. Device A 501 may receive a plurality of data packets, a subset of which include an address of device B 502. Device A 501 may identify the data packets including an address of device B as the data packets to use in the pairing with device B 502. The data exchanged may include “Key A,” “Key B,” other keys, nonces, and other information. Device A 501 and device B 502 may create a link key as a function of the data exchanged between device A 501 and device B 502.

FIGS. 6A, 6B, and 6C illustrate examples of identifying a device that is paired using an acoustic signal, according to some examples. As shown, FIG. 6A includes device A 601, an acoustic signal 611, and electromagnetic signals 612-613. Device A 601 may receive or detect acoustic signal 611 and electromagnetic signal 612-613, but may be unaware of each signals' source. Device A 601 may perform an inquiry to determine which signal has originated from another device that is to be paired with device A 601. Each signal may be encoded with data representing a parameter associated with its source. As shown, for example, acoustic signal 611 may be encoded with a name of its source (e.g., “Jambox”), electromagnetic signal 612 may be encoded with a name of its source (e.g., “Headset”), and electromagnetic signal 613 may be encoded with a name of its source (e.g., “Jambox”). Device A 601 may compare the parameters encoded in signals 611 and 612 and determine that there is no match (e.g., “Jambox” and “Headset” are different). Device A 601 may compare the parameters encoded in signals 611 and 613 and determine a match (e.g., both are “Jambox”). Thus, device A 601 may determine that the source of electromagnetic signal 613 is the device with which it should be paired. Still, other ways of determining a match may be used.

As shown, FIG. 6B includes device A 601, an acoustic signal 614, and electromagnetic signals 615-616. Device A 601 may receive acoustic signal 614 and electromagnetic signal 615-616. In some examples, device A 601 may determine which device to pair with using a process of elimination or based on mismatches. As shown, for example, acoustic signal 614 may be encoded with an address range and a functionality of its source, electromagnetic signal 615 may be encoded with a functionality of its source, and electromagnetic signal 616 may be encoded with an address and a functionality of its source. Device A 601 may determine that the functionality in signal 615 and the functionality in signal 616 both are the same as the functionality in signal 614 (e.g., “generate audio”). However, device A 601 may determine that the address in signal 616 is outside the range of the address range in signal 614 and may determine a mismatch. Thus, device A 601 may determine that the source of signal 616 is not the device that is to be paired with device A 601. Having eliminated signal 616, device A 601 may determine that the source of device 615 is the device that is to be paired with device A 601. Still, other ways of determining a match may be used.

As shown, FIG. 6C includes device A 601, an acoustic signal 617, and electromagnetic signals 618-619. Device A 601 may receive acoustic signal 617 and electromagnetic signal 618-619. Device A 601 may determine whether a comparison of the data in signals 617 and 619 result in a match. In some examples, the data included under a parameter type may or may not be exhaustive. As shown, for example, acoustic signal 617 may include data representing one functionality (e.g., “generate audio”) but its source may perform other functionalities (e.g., generating light, and others). Electromagnetic signal 619 may include data representing two functionalities (e.g., “generate audio” and “generate light”). In some examples, a match may be found only if all functionalities included in the signals are the same. In some examples, a match may be found if one or more of the functionalities included in the signals are the same. Still, other ways of determining a match may be used.

In some examples, device A 601 may determine a match between data in an acoustic signal and data in an electromagnetic signal by determining a best match. A best match may be determined by a level of similarity between the parameters, a weight or significance of a parameter type, and the like. As shown, for example, acoustic signal 614 may be encoded with a name and a functionality of its source, electromagnetic signal 615 may be encoded with a name and a functionality of its source, and electromagnetic signal 616 may be encoded with one or more functionalities of its source. Device A 601 may determine that a name in signal 617 matches a name in signal 618 (e.g., “Jambox”), and a functionality in signal 617 matches a functionality in signal 619 (e.g., “generate audio”). In some examples, the significance of a match of one parameter (e.g., a name) may be greater than a match of another parameter (e.g., a functionality). Thus, device A 601 may determine a match between the data of signals 617 and 618, and may identify the source of signal 618 as the device to be paired with. Still, other ways of determining a match may be used.

In some examples, after a match is determined, device A 601 may perform an updating of the coding table 620. As shown for example, acoustic signal 617 may include a name (e.g., “Jambox”) and one functionality (e.g., “generate audio”), and electromagnetic signal 618 may include the name (e.g., “Jambox”) and another functionality (e.g., “generate vibration”). The acoustic signal 617 may be decoded using a coding table, which may map an acoustic signal template to a meaning. As discussed above, for example, device A 601 may determine that there is a match between the data of signals 617 and 618. The match may be based on a similarity of a subset of parameters included in signals 617 and 618 (e.g., the names in the signals 617 and 618 are the same). Device A 601 may determine that electromagnetic signal 618 includes an additional functionality of the source. Device A 601 may update the coding table to add the additional information. For example, the acoustic signal template that corresponds with acoustic signal 617 may originally map to the parameters, “Jambox” and “generate audio.” After updating the coding table, the acoustic signal template may map to the parameters, “Jambox” and “generate audio, generate vibration.” Still, other types of updates and modifications may be performed to the coding table.

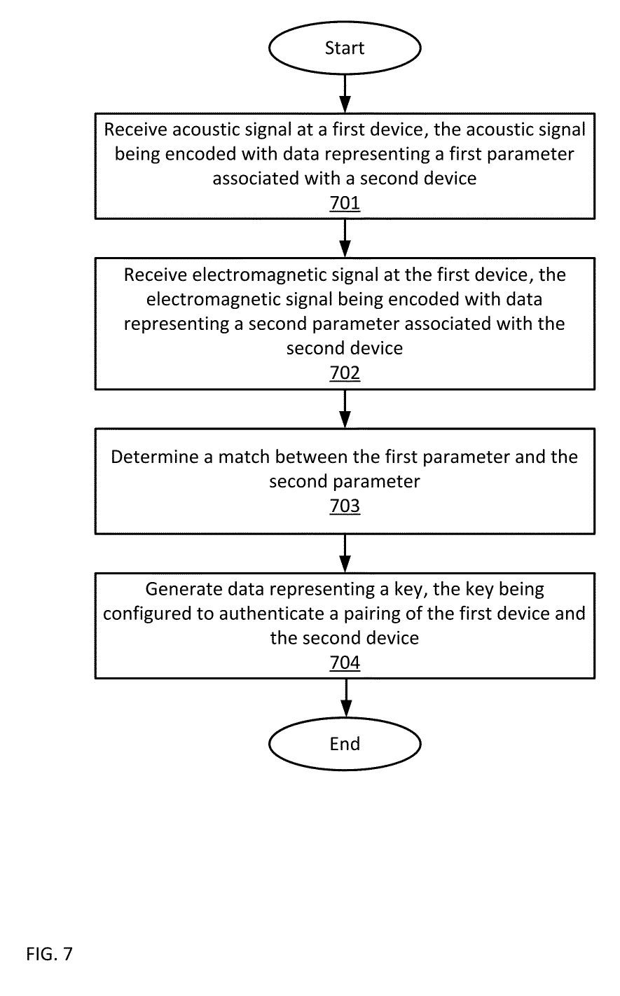

FIG. 7 illustrates an example of a process for a pairing manager, according to some examples. At 701, an acoustic signal may be received at a first device. The acoustic signal may be received at a microphone coupled to the first device. The acoustic signal may be encoded with data representing a first parameter associated with a second device. At 702, an electromagnetic signal may be received at the first device. The electromagnetic signal may be received at an antenna coupled to the first device. The electromagnetic signal may be encoded with data representing a second parameter associated with the second device. At 703, a match may be determined between the first parameter and the second parameter. The match may be determined based on an exact match, a substantial similarity, a best match, a process of elimination, a mismatch, and the like. Based on the match, the second device may be identified or authenticated to be the device with which the first device is to pair. At 704, a pairing of the first device and the second device may be established. Data representing a key may be generated, and the key may be used to authenticate the pairing of the first device and the second device. A pairing may be an ad hoc network between the first device and the second device. A pairing may be a secure connection between the first device and the second device. The key may be used to encrypt or decrypt data exchanged between the first device and the second device. The key may be a basis for creating additional encryption keys for securing the communications between the first device and the second device. Generation of the key may be a function of other information in addition to the first parameter and the second parameter, such as keys, nonces, and the like. Based on the pairing, the first device and the second device may communicate in an ad hoc or peer-to-peer network. The first device and the second device may have a secure connection. The first device and the second device may have a link key, which may be used to authenticate the secure connection.

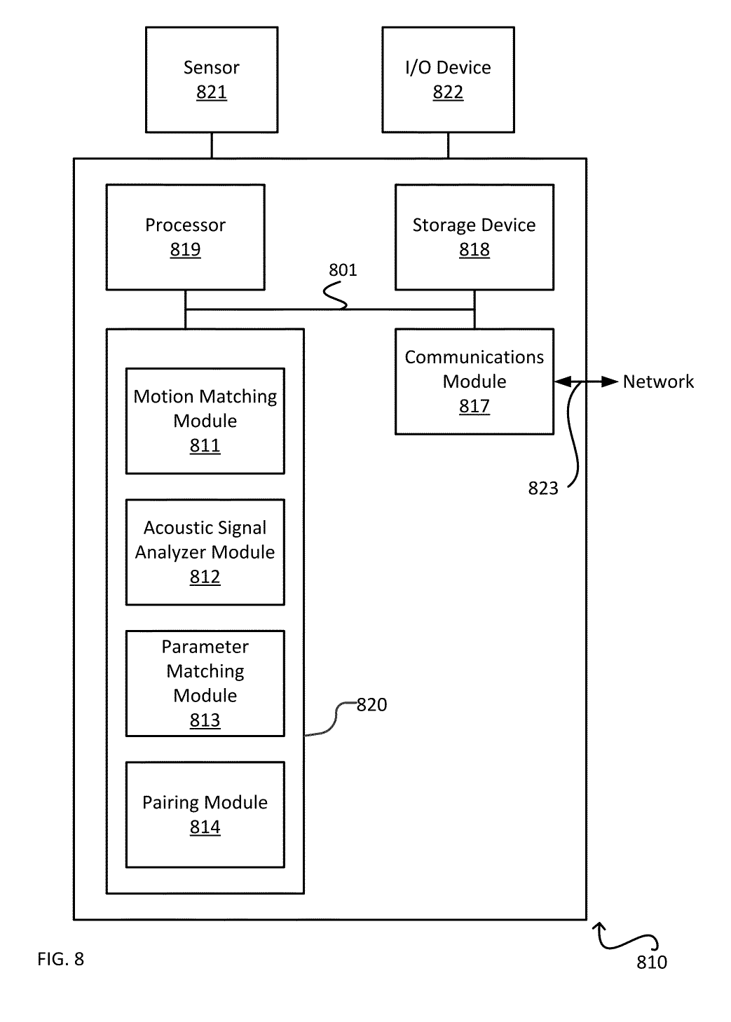

FIG. 8 illustrates a computer system suitable for use with a pairing manager, according to some examples. In some examples, computing platform 810 may be used to implement computer programs, applications, methods, processes, algorithms, or other software to perform the above-described techniques. Computing platform 810 includes a bus 801 or other communication mechanism for communicating information, which interconnects subsystems and devices, such as processor 819, system memory 820 (e.g., RAM, etc.), storage device 818 (e.g., ROM, etc.), a communications module 817 (e.g., an Ethernet or wireless controller, a Bluetooth controller, etc.) to facilitate communications via a port on communication link 823 to communicate, for example, with a computing device, including mobile computing and/or communication devices with processors. Processor 819 can be implemented with one or more central processing units (“CPUs”), such as those manufactured by Intel® Corporation, or one or more virtual processors, as well as any combination of CPUs and virtual processors. Computing platform 810 exchanges data representing inputs and outputs via input-and-output devices 822, including, but not limited to, keyboards, mice, audio inputs (e.g., speech-to-text devices), speakers, microphones, user interfaces, displays, monitors, cursors, touch-sensitive displays, LCD or LED displays, and other I/O-related devices. An interface is not limited to a touch-sensitive screen and can be any graphic user interface, any auditory interface, any haptic interface, any combination thereof, and the like. Computing platform 810 may also receive sensor data from sensor 821, including a heart rate sensor, a respiration sensor, an accelerometer, a motion sensor, a galvanic skin response (GSR) sensor, a bioimpedance sensor, a GPS receiver, and the like.

According to some examples, computing platform 810 performs specific operations by processor 819 executing one or more sequences of one or more instructions stored in system memory 820, and computing platform 810 can be implemented in a client-server arrangement, peer-to-peer arrangement, or as any mobile computing device, including smart phones and the like. Such instructions or data may be read into system memory 820 from another computer readable medium, such as storage device 818. In some examples, hard-wired circuitry may be used in place of or in combination with software instructions for implementation. Instructions may be embedded in software or firmware. The term “computer readable medium” refers to any tangible medium that participates in providing instructions to processor 819 for execution. Such a medium may take many forms, including but not limited to, non-volatile media and volatile media. Non-volatile media includes, for example, optical or magnetic disks and the like. Volatile media includes dynamic memory, such as system memory 820.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read. Instructions may further be transmitted or received using a transmission medium. The term “transmission medium” may include any tangible or intangible medium that is capable of storing, encoding or carrying instructions for execution by the machine, and includes digital or analog communications signals or other intangible medium to facilitate communication of such instructions. Transmission media includes coaxial cables, copper wire, and fiber optics, including wires that comprise bus 801 for transmitting a computer data signal.

In some examples, execution of the sequences of instructions may be performed by computing platform 810. According to some examples, computing platform 810 can be coupled by communication link 823 (e.g., a wired network, such as LAN, PSTN, or any wireless network) to any other processor to perform the sequence of instructions in coordination with (or asynchronous to) one another. Computing platform 810 may transmit and receive messages, data, and instructions, including program code (e.g., application code) through communication link 823 and communication interface 817. Received program code may be executed by processor 819 as it is received, and/or stored in memory 820 or other non-volatile storage for later execution.

In the example shown, system memory 820 can include various modules that include executable instructions to implement functionalities described herein. In the example shown, system memory 820 includes motion matching module 811, acoustic signal analyzer module 812, parameter matching module 813, and pairing module 814.

Although the foregoing examples have been described in some detail for purposes of clarity of understanding, the above-described inventive techniques are not limited to the details provided. There are many alternative ways of implementing the above-described invention techniques. The disclosed examples are illustrative and not restrictive.

What is claimed:

1. A method, comprising:
receiving an acoustic signal at a microphone coupled to a first device, the acoustic signal being encoded with data representing a first parameter associated with a second device;
receiving an electromagnetic signal at an antenna coupled to the first device, the electromagnetic signal being encoded with data representing a second parameter associated with the second device;
determining a match between the first parameter and the second parameter; and
generating data representing a key configured to authenticate a pairing of the first device and the second device.

2. The method of claim 1, further comprising:
selecting one or more acoustic signal templates stored in a memory;
receiving data representing the first parameter based on user input;
storing an association between the one or more acoustic signal templates and the first parameter; and
determining another match between the acoustic signal and the one or more acoustic signal templates.

3. The method of claim 1, further comprising:
detecting motion associated with the first device; and
enabling processing of the acoustic signal.

4. The method of claim 3, further comprising:
receiving motion data from a sensor coupled to the first device;
determining another match between the motion data to a motion template; and
receiving the acoustic signal within a threshold time period since the receiving the motion data.

5. The method of claim 1, further comprising:
generating an audio signal comprising a first audio channel at the first device; and
transmitting data representing a second audio channel to the second device.

6. The method of claim 1, further comprising:
transmitting data representing a setting associated with the first device to the second device.

7. The method of claim 1, further comprising:
creating an ad hoc network between the first device and the second device.

8. The method of claim 1, further comprising:
pairing the first device and the second device using a Bluetooth communications protocol.

9. The method of claim 1, wherein the second parameter associated with the second device comprises one of an address, a functionality, and a name associated with the second device.

10. The method of claim 1, further comprising:
generating another acoustic signal, the another acoustic signal being encoded with data representing a third parameter associated with the first device; and
transmitting another electromagnetic signal, the another electromagnetic signal being encoded with data representing a fourth parameter associated with the first device.

11. A system, comprising:
a memory configured to store an acoustic signal received at a microphone coupled to a first device, the acoustic signal being encoded with data representing a first parameter associated with a second device, and to store an electromagnetic signal received at an antenna coupled to the first device, the electromagnetic signal being encoded with data representing a second parameter associated with the second device; and
a processor configured to determine a match between the first parameter and the second parameter, and to generate data representing a key configured to authenticate a pairing of the first device and the second device.

12. The system of claim 11, wherein the processor is further configured to generate an audio signal comprising a first audio channel at the first device, and to transmit data representing a second audio channel to the second device.

13. The system of claim 11, wherein the processor is further configured to transmit data representing a setting associated with the first device to the second device.

14. The system of claim 11, wherein the processor is further configured to create an ad hoc network between the first device and the second device.

15. The system of claim 11, wherein the processor is further configured to pair the first device and the second device using a Bluetooth communications protocol.

16. The system of claim 11, wherein the second parameter associated with the second device comprises an address or a name associated with the second device.

17. The system of claim 11, wherein the processor is further configured to generate another acoustic signal, the another acoustic signal being encoded with data representing a third parameter associated with the first device, and to transmit another electromagnetic signal, the another electromagnetic signal being encoded with data representing a fourth parameter associated with the first device.

18. The system of claim 11, wherein the processor is further configured to receive motion data from a sensor coupled to the first device, to determine another match between the motion data to a motion template, and to receive the acoustic signal within a threshold time period since the motion data is received.

19. A media device, comprising:
a speaker;
a microphone configured to receive an acoustic signal, the acoustic signal being encoded with data representing a first parameter associated with a second device;
an antenna configured to receive an electromagnetic signal, the electromagnetic signal being encoded with data representing a second parameter associated with the second device; and
a processor configured to determine a match between the first parameter and the second parameter, and to generate data representing a key configured to authenticate a pairing of the first device and the second device.

20. The media device of claim 19, further comprising:
a sensor configured to detect a motion configured to enable a processing of the acoustic signal.
